(19) United States
(12) Patent Application Publication
(10) Pub. No.: US 2014/0141242 A1
(43) Pub. Date: May 22, 2014

(54) TWO LAYER COATING FOR FIBERGLASS TRANSMISSION AND DISTRIBUTION COMPONENTS

(71) Applicant: Electric Power Research Institute, Inc., Charlotte, NC (US)

(72) Inventors: Andrew John Phillips, Harrisburg, NC (US); Jiong Liu, East Brunswick, NJ (US); Kenneth C. Eberts, Westfield, NJ (US); Ganesh Skandan, Easton, PA (US)

(73) Assignee: Electric Power Research Institute, Inc., Charlotte, NC (US)

(21) Appl. No.: 14/073,258

(22) Filed: Nov. 6, 2013

Related U.S. Application Data
(60) Provisional application No. 61/725,758, filed on Nov. 13, 2012.

(51) Int. Cl. H01B 7/18

(52) U.S. Cl. CPC H01B 7/1875
USPC 428/383

(57) ABSTRACT

A composite component having a two layer protective coating is disclosed. The composite component is adapted for use in the power transmission industry and includes a fiberglass inner core, a pliable first coating layer applied to the fiberglass core, and a hard second coating layer applied to the first coating layer.

### BACKGROUND OF THE INVENTION

This invention relates to composite transmission and distribution components, and more particularly, to protecting fiberglass components from damage due to handling and environmental issues.

The first composite component designs were developed during the 1960's. From the beginning the advantages of utilizing composite materials in components were clear. The composite components offered:
low weight, which made handling and installation easier;
resistance to vandalism; and
an improved contamination flashover performance over glass and porcelain materials if the housing material is hydrophobic.

These advantages have provided a strong impetus for the further development of this technology. However, not all manufacturers were equally successful in producing well performing composite components. While some units have performed exceptionally well, other designs have failed miserably, making it difficult for users to predict whether or not a new design will perform well. The reason for this is the fact that the organic materials used to construct composite components are prone to ageing, which may severely deteriorate the components electrical and mechanical performance over time.

Today, fiberglass components are utilized in numerous applications in transmission and distribution systems. Examples include poles, cross-arms, guy strain insulators, hotsticks, arrestors, bushings and composite insulators. In some of these applications the fiberglass is bare to the environment, or it may be coated with epoxy paint or a rubber weathershed system.

Degradation occurs on fiberglass components that are directly subjected to the environment due to UV, moisture, contamination, and rough handling. In the cases where epoxy coatings are used these coatings have been shown to be fragile and the fiberglass easily exposed and consequently degraded. In the case of composite insulators, the rubber housings have been shown to be tough, but if compromised, moisture can come in contact with the fiberglass insulator which in-turn may result in failure.

Accordingly, this invention aims to impart new surface functionality to GRP (Glass-Reinforced Pultruded)/GFR (Glass Fiber-Reinforced) components, such as rods, not offered by existing technologies—epoxy coating, a veil, or a rubber housing. The coating technology disclosed here provides damage-resistance during handling and installation, while enhancing environmental resistance.

### BRIEF SUMMARY OF THE INVENTION

These and other shortcomings of the prior art are addressed by the present invention, which provides a two layer coating adapted to protect fiberglass components used in transmission and distribution systems.

According to one aspect of the invention, a composite component adapted for use in the power transmission industry includes a fiberglass inner core, a pliable first coating layer applied to the fiberglass core, and a hard second coating layer applied to the first coating layer.

According to another aspect of the invention, a composite component adapted for use in the power transmission industry includes a fiberglass inner core, a pliable first coating layer applied to the fiberglass core, and a hard second coating layer applied to the first coating layer. The first coating layer is enriched with ultraviolet absorbers to block ultraviolet light from penetrating into and degrading the fiberglass core. The second coating layer provides mechanical resistance to scratching, abrasion, and impact to prevent the fiberglass core from being exposed to the environment.

### BRIEF DESCRIPTION OF THE DRAWINGS

The subject matter that is regarded as the invention may be best understood by reference to the following description taken in conjunction with the accompanying drawing figures in which:

FIG. 1 shows a 2 layer coating: Top layer for damage resistance and lower layer for UV protection—the lower layer is “softer” than the top layer;

FIG. 2 shows an optical micrograph of an intact coating, after end-fittings have been crimped on;

FIG. 3 shows increases in mechanical strength of guy strain and composite insulators due to coating;

FIG. 4 is a comparison of resistance to dry band arcing—left sample uncoated, right coated;

FIG. 5 shows bonding of vulcanized rubber to the coating;

FIGS. 6A and 6B show improvement in composite insulator impact resistance compared with commercially available hard coating;

FIG. 7A shows microstructure of Formulation B;

FIG. 7B shows UV-VIS transmission spectra of coatings formed by Formulation B and other typical formulations;

FIG. 8 shows results of Taber weight loss testing on uncoated (blank) composite and composite coated with Formulation B and other typical formulations;

FIG. 9 shows results of tape test adhesion on Formulation B applied to composite flat (left) and rod (right);

FIG. 10A shows microstructure of Formulation B;

FIG. 10B shows UV-VIS transmission spectra of coatings formed by Formulation B and other typical formulations;

FIG. 11 shows results of Taber weight loss testing on uncoated (blank) composite and composite coated with Formulation C (coated);

FIG. 12 shows results of tape test adhesion on Formulation C applied to composite flats;

FIGS. 13A and 13B show macro photograph (FIG. 13A) and measurement data (FIG. 13B) for impact testing at different impact energies;

FIG. 14 shows typical surface micrographs of uncoated, control insulator rod (left) and rod coated with Formulation C (right) after 1500 hours of UV weathering;

FIGS. 15A-15C show results of UV weatherability testing showing untested samples (FIG. 15A), fluorescent UV condensation results (FIG. 15B), and xenon with water (FIG. 15C);

FIG. 16 shows average leakage current as a function of voltage for moisture-exposed samples compared with both air and an unexposed, dry control rod. The approximate voltage range at which flashover was observed is indicated by red ovals;

FIGS. 17A-17C show results of the 1 kV tracking test comparing coated (right) and uncoated (left) control flats over time;

FIG. 18A shows cross sectional micrographs of uncoated;

FIG. 18B shows Formulation C coated rods at 500× magnification after crimping. A cross-sectioned rod with an end fitting applied is shown at left to indicate the regions seen in the micrographs at right; and

FIG. 19 shows average load to failure for pull tested rods.

### DETAILED DESCRIPTION OF THE INVENTION

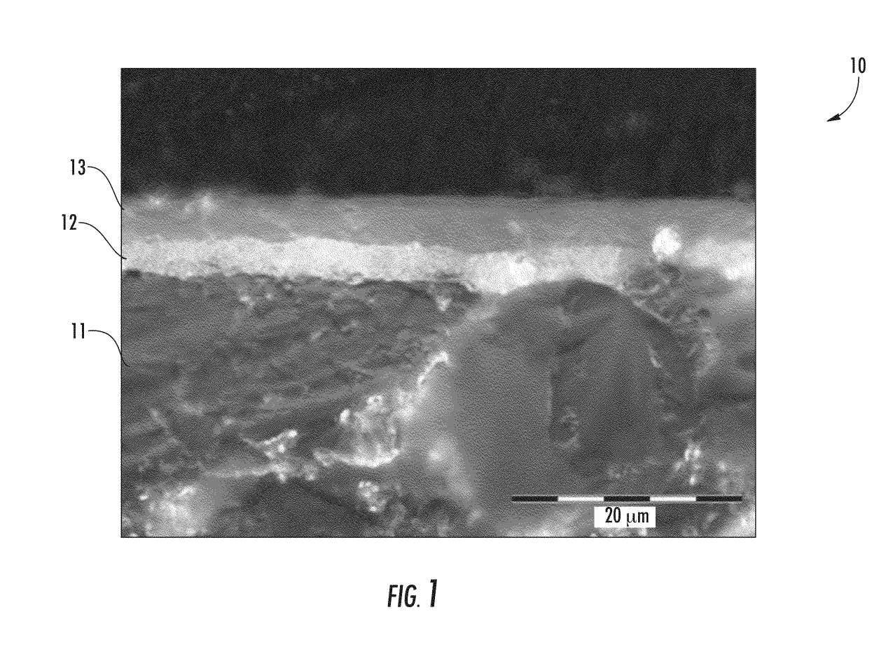

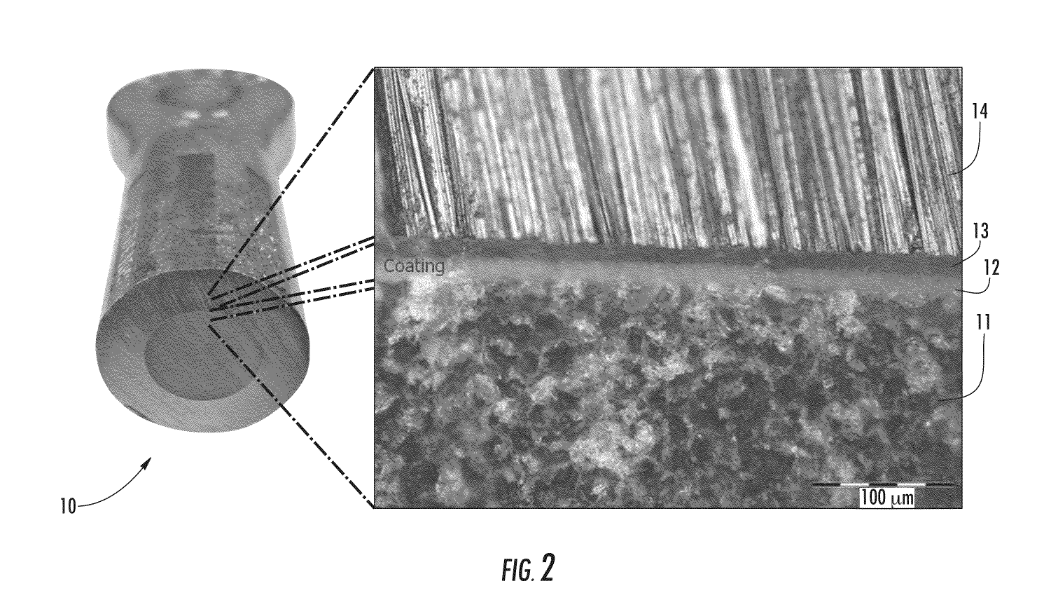

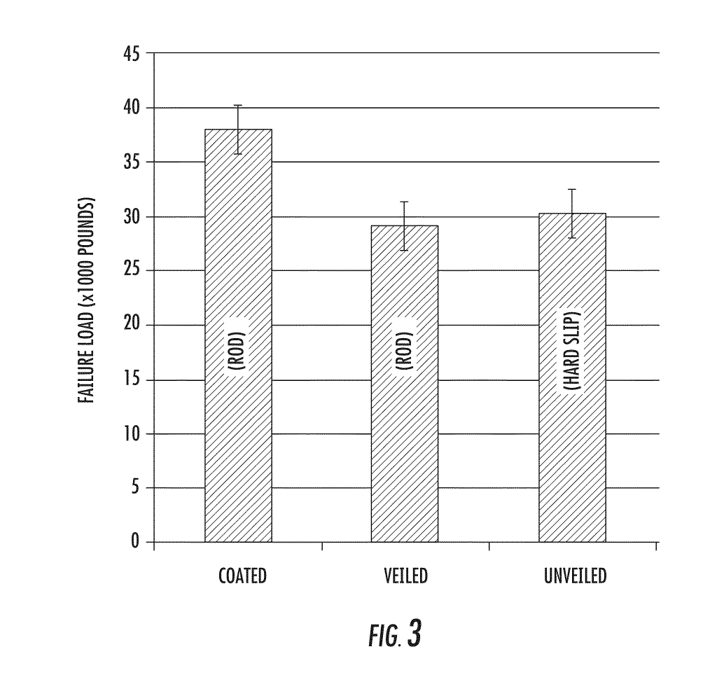

Referring to the drawings, an exemplary composite component having a two layer protective coating according to an embodiment of the invention is illustrated in FIGS. 1 and 2 and shown generally at reference numeral 10. As shown, the composite component 10 includes a fiberglass core or rod 11 having a pliable first coating layer 12 applied to the rod 11 and a hard second coating layer 13 applied to the first coating layer 12.

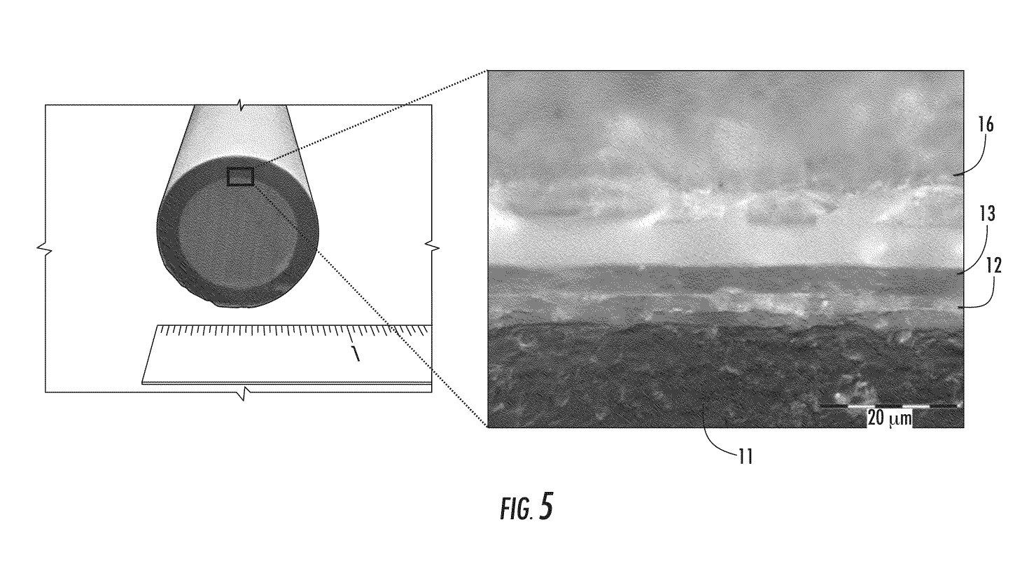

One of the advantages of the two layer coating is that it bonds well to fiberglass, eliminating the need to sandblast or grind the surface of fiberglass rods to ensure a good bond, thereby reducing manufacturing costs and adding functionality. In addition, rubber can bond well to the coating utilizing standard vulcanizing manufacturing procedures. This enables the utilization of the coating in composite insulator applications where a redundant barrier 16 to moisture penetration or handling damage may be desirable. See FIG. 5.

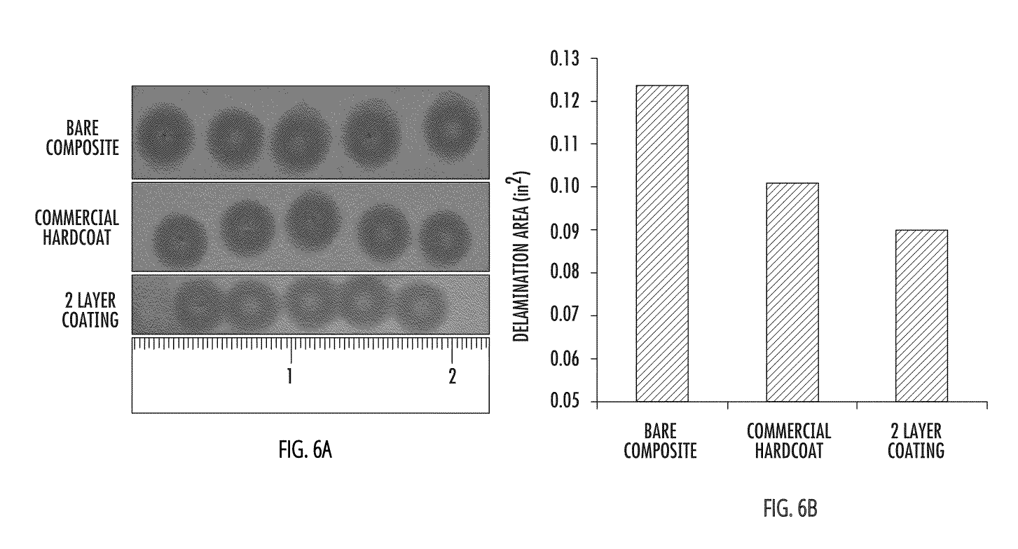

The hard second coating layer 13 provides mechanical resistance to handling (scratch, abrasion and impact) which could result in delamination (See FIG. 6—Delamination causes darkening within the composite), is dense, and acts as a moisture barrier (water causes stress corrosion cracking). The pliable first coating layer 12 is engineered to be UV resistant to block UV rays from penetrating into the fiberglass rod, to prevent cracking of the second coating layer 13, and to provide additional mechanical strength when a metal end fitting is swaged onto the composite component.

Metal end fittings are usually swaged (crimped) on to composite components to allow mechanical attachment to structures, conductors, and other hardware. The mechanical strength of the components is often limited by this swaged interface. Common failures include the metal end fittings slipping off of the composite components.

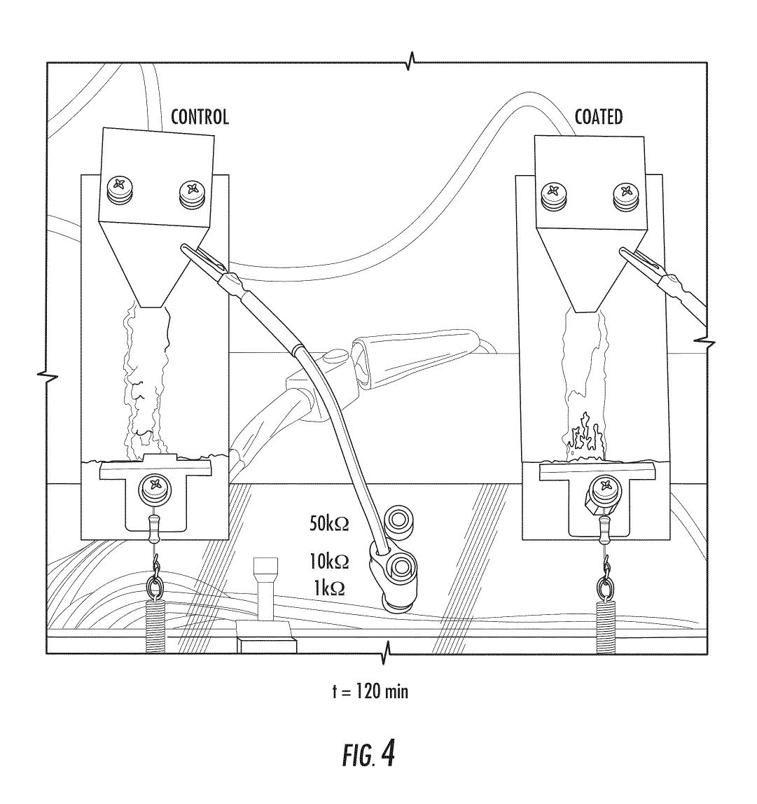

Generally, hard coatings are not pliable and crack when applied to hard surfaces, especially when metallic end-fittings are crimped on to the ends of a composite component because of the lack of ductility. As shown in FIG. 2 (not cracking) and 3 and discussed above, the first coating layer 12 not only helps prevent cracking of the second coating layer 13, but it also increases mechanical swage strength between the fiberglass rod 11 and metal end fittings 14. This is due to the fact that the first coating layer 12 is pliable, thereby allowing the coating to mold itself around the fiberglass rod 11, increase mechanical clamping force, and prevent slipping. In addition, the two layer coating improves resistance to electrical (arcing) activity compared to fiberglass, FIG. 4.

For testing purposes, three coating formulations were used—Formulation A, Formulation B, and Formulation C. The testing results for all three formulations can be seen in the various Figures, but only Formulation B and Formulation C are discussed below in detail.

### EXAMPLE 1

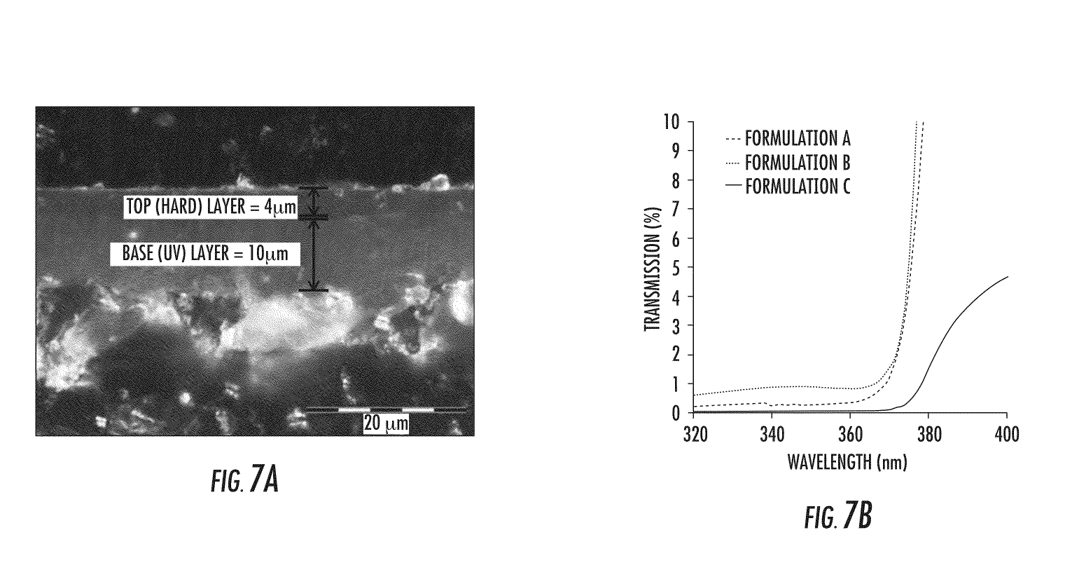

Coating Formulation B consisted of an organic-inorganic hybrid compound which was synthesized in an aqueous medium. A dip coating process was used to apply the coating formulation in a uniform manner on composite insulator rods and flats, followed by thermal curing. FIG. 1 shows the microstructural cross section of a composition comprised of 2 layers prepared with Formulation B. The first layer deposited has been enriched with inorganic ultraviolet absorbers which serve to protect the underlying epoxy matrix from the effects of weathering by blocking most light below 360 nm in wavelength. UV-VIS transmission spectra of three possible compositions, including the one formed by Formulation B, are also shown in FIGS. 7A and 7B.

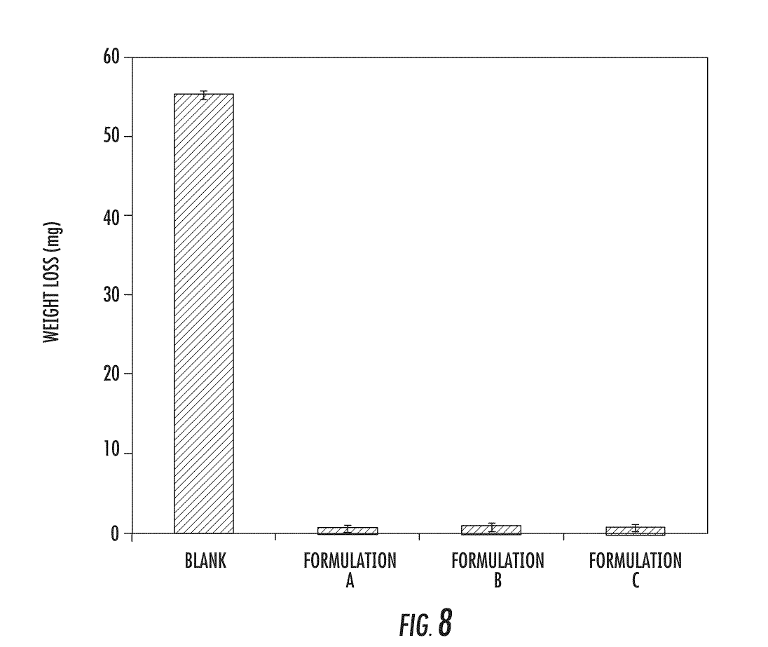

Coated, flat specimens were used to quantify the adhesion and abrasion resistance with standardized testing. Taber abrasion was evaluated with the weight loss method per ASTM D4060. A Taber Industries 5130 abraser with a Calibrase CS-17 wheel set was used to apply 1500 cycles under a 1 kg load. Samples were weighed before and after the test to determine the mass of material removed as a result of abrasion. Results are shown in FIG. 8.

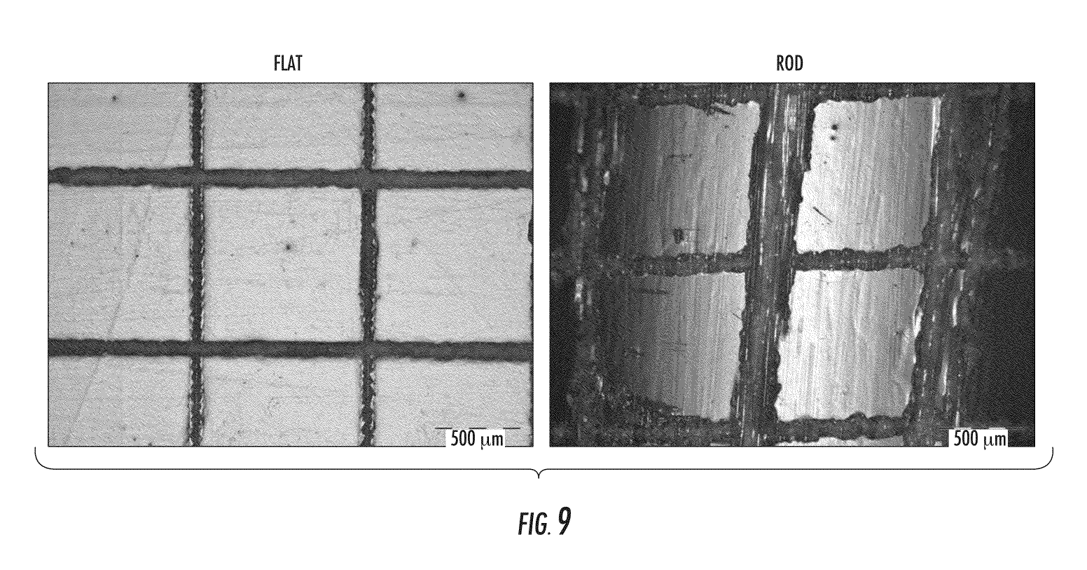

Coating adhesion was evaluated with the tape test method per ASTM D3359. An 11 toothed cutter with 1 mm spacing was used to create a crosshatch of 100 squares on a flat sample. A similar crosshatch was made with a razor on a rod sample. The amount of coating removal after application of a pressure-sensitive tape was evaluated by microscope, as shown in FIG. 9. These results show 0% removal of the Formulation B film, giving it the highest possible adhesion rating of 5B.

### EXAMPLE 2

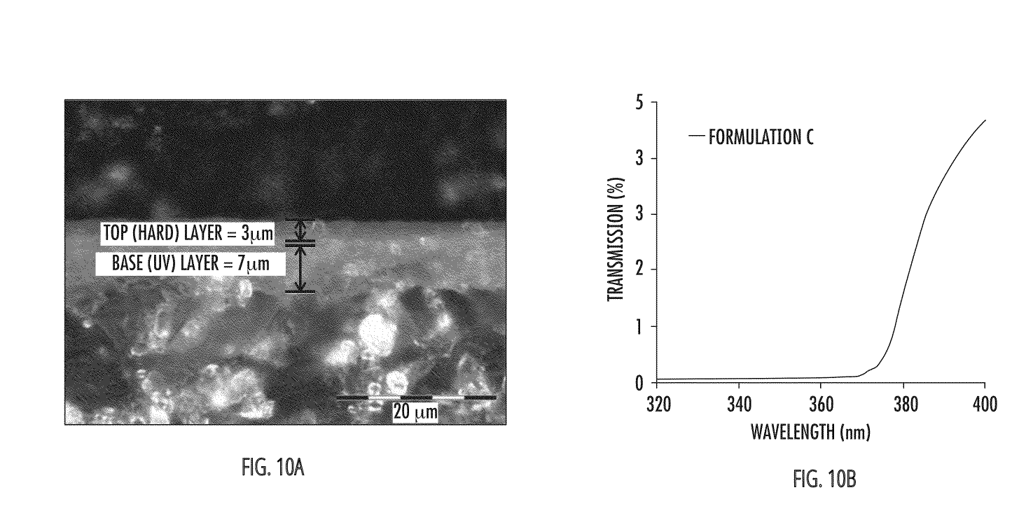

The Formulation C coating structure consists of two layers. The bottom layer is formed from a sol-gel coating solution having ultraviolet absorbers (UVAs), and the top layer is formed from another sol-gel coating solution. The coatings were deposited as per the following protocol. A dip coating process is used to apply the coating formulation in a uniform manner on composite insulator rods and flats, followed by thermal curing. The bottom layer is first deposited and cured, followed by deposition and curing of the top layer. The dip rate and solids loading of the coating formulation is controlled to obtain the desired film thickness. FIG. 1 shows the microstructural cross section of a composition comprised of 2 layers prepared with Formulation C. The bottom layer is enriched with UVAs which serve to protect the underlying composite material from the effects of weathering by preventing the transmission of most light below 360 nm in wavelength. The particles also influence the mechanical properties of the resulting coating, most notably by decreasing wear resistance which is indicative of a softer coating. A UV-VIS transmission spectrum of the coating structure formed with Formulation C is also shown in FIGS. 10A and 10B.

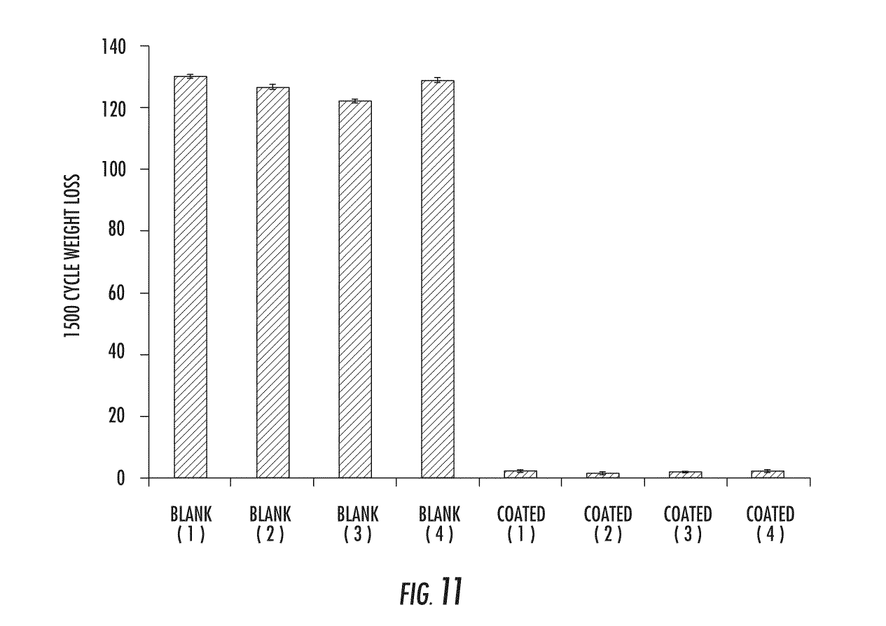

Coated, flat specimens were used to quantify the abrasion, adhesion, impact and electrical tracking resistance with standardized tests. Taber abrasion was evaluated with the weight loss method per ASTM D4060. A Taber Industries 5130 abraser with a Calibrase CS-17 wheel set was used to apply 1500 cycles under a 1 kg load. Samples were weighed before and after the test to determine the mass of material removed as a result of abrasion. Results are shown in FIG. 11.

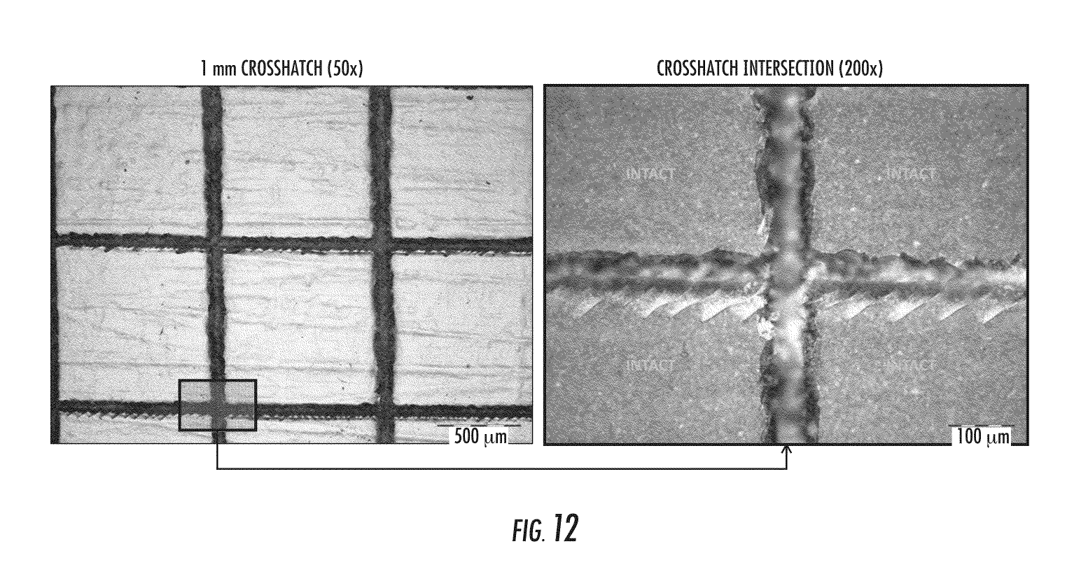

Coating adhesion was evaluated with the tape test method per ASTM D3359. An 11 toothed cutter with 1 mm spacing was used to create a crosshatch of 100 squares on a flat sample. The amount of coating removal after application of a pressure-sensitive tape was evaluated by microscope, as shown in FIG. 12. These results show 0% removal of the Formulation C film, giving it the highest possible adhesion rating of 5B.

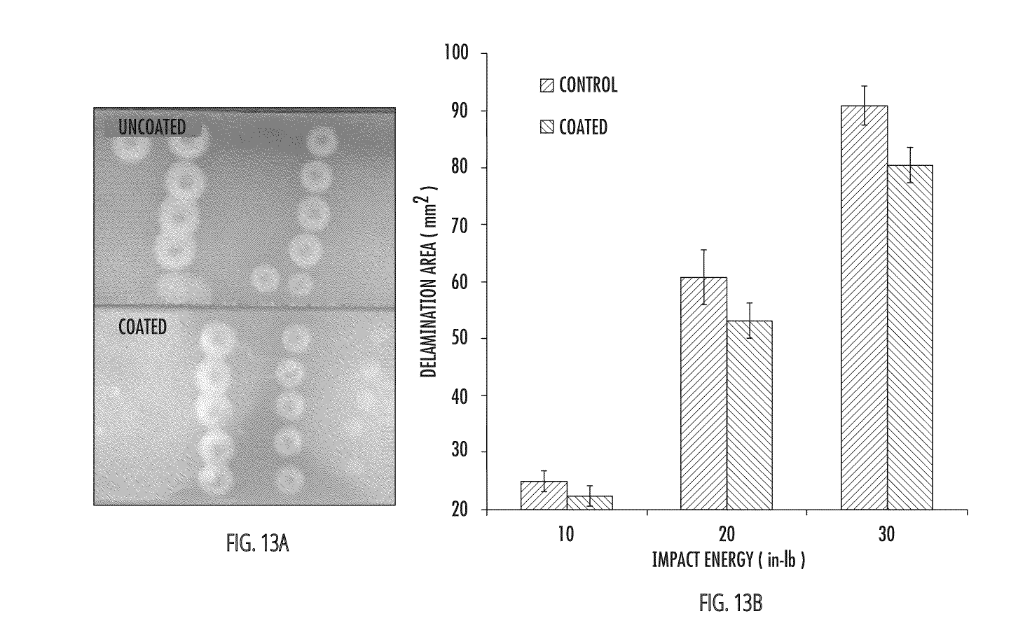

Impact resistance was evaluated under the guidelines of ASTM D5420. Assessments were made by visual inspection and area measurements of the delamination zone. Fiber composite will whiten in the region of deformation, indicating delamination of the fiber and matrix. It is this area that can be compared to observe the effect of the coating on impact resistance. See FIG. 13.

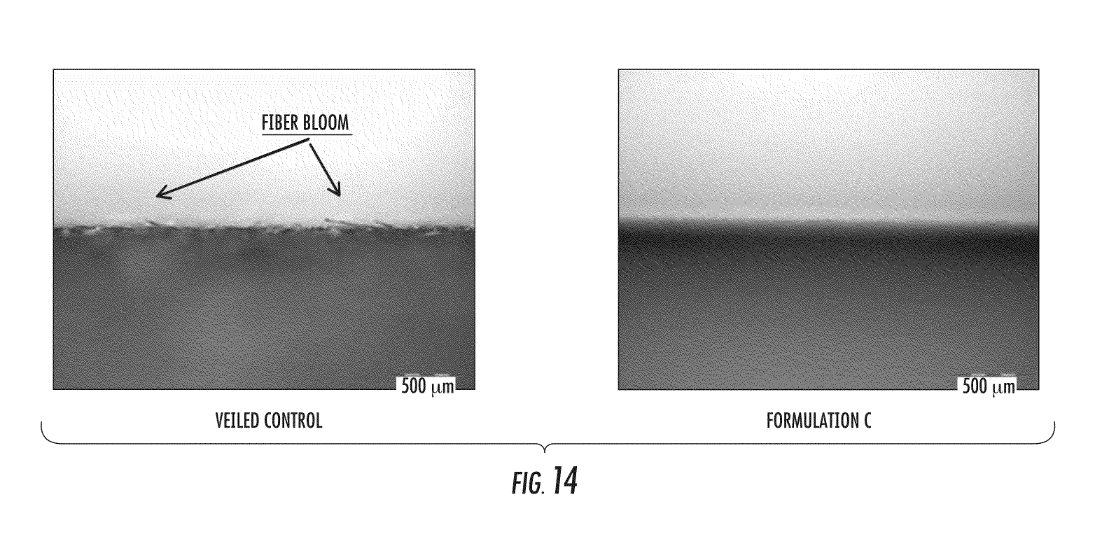

Standard insulator rods with the same composite structure as the flats, prepared with and without coatings, were tested for weatherability, moisture penetration and crimping performance. Accelerated weathering tests were conducted under the guidelines of ASTM G53, Fluorescent UV-Condensation. This testing utilizes a UVCON test chamber fitted with fluorescent UV lamps, forced condensation and heating. Samples were subjected to a cyclic exposure of UV at 60° C. and humidity at 50° C. Accelerated weathering by Xenon UV exposure was performed in parallel with UVCON under the guidelines of ASTM G26, xenon-arc type with water. This testing utilizes a Xenon test chamber fitted with a rotating sample rack and humidity controlled to ˜95%. This test was first run continuously for 1500 hours before being interrupted for sample assessment. The control rods showed obvious signs of fiber bloom when viewed on edge under a microscope, while the nanocomposite-coated rods showed very few signs of deterioration. Typical micrographs are shown in FIG. 14.

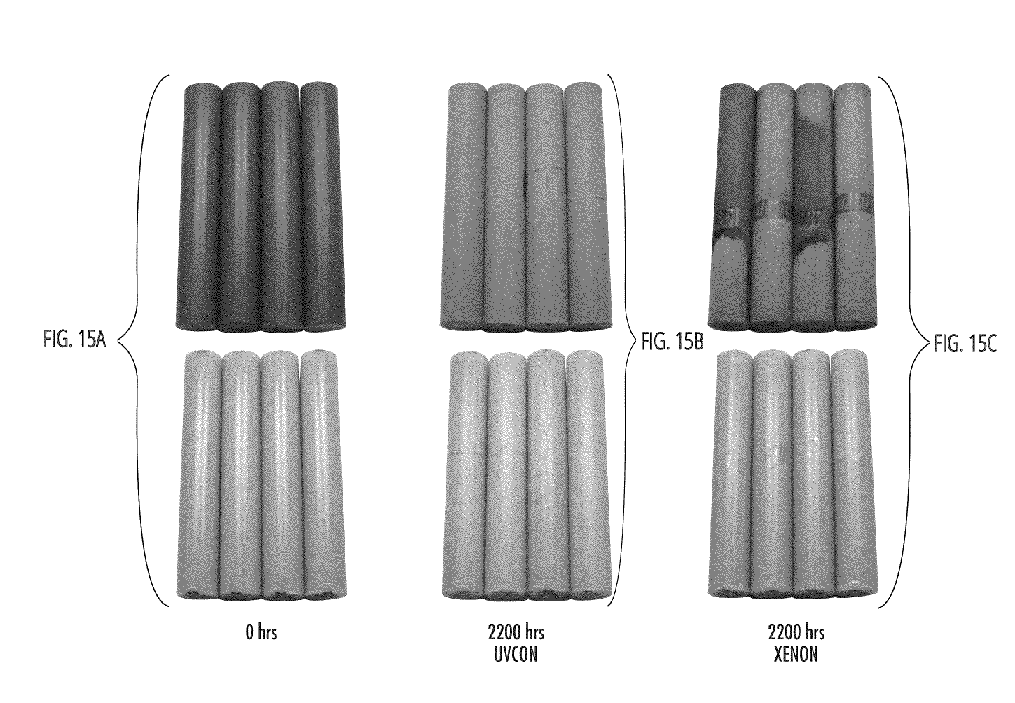

A second, larger set of samples were then tested for statistical significance. Macro photographs were taken to compare the visual appearance of the rods before and after 2200 total hours of testing by each exposure method. The reflectivity of the rod surface can be used to gauge the degree of surface damage from weathering, as shown in FIG. 15. The control samples lose their glossy surface, indicating poor weatherability, while the coated samples show minimal change in appearance, indicating good weatherability.

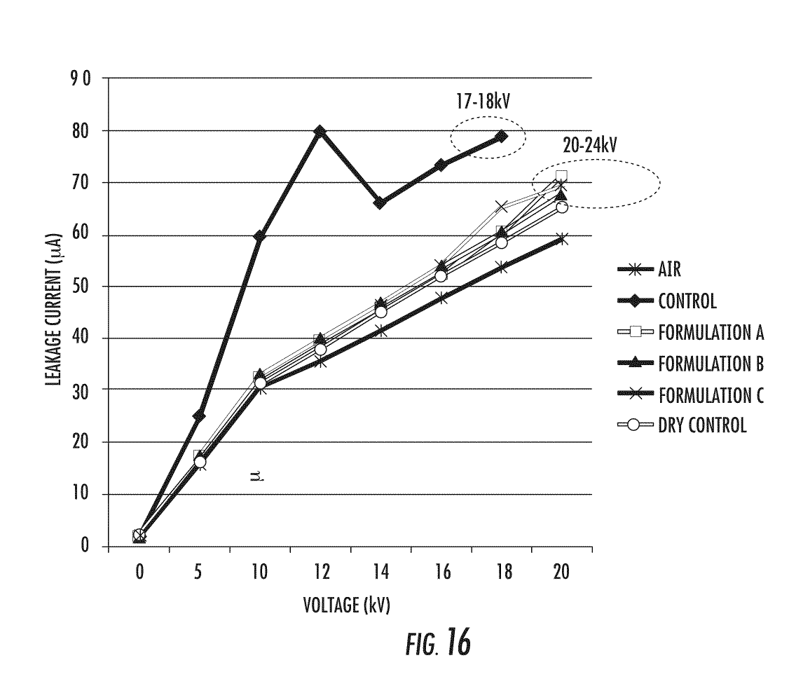

Moisture penetration testing has been conducted on coated and uncoated rod samples by stressing the samples with exposure to a dense water fog, generated by an ultrasonic transducer, for 100 hours at room temperature. Electrical properties of the samples were measured before and after the stress test. FIG. 16 plots the average leakage current as a function of voltage for coated and control samples after moisture exposure. Flashover is typically observed at some point during the voltage sweep and noted. The averaged values of these measurements are graphed in FIG. 16. The coating has improved the electrical performance of the insulator by preventing moisture penetration.

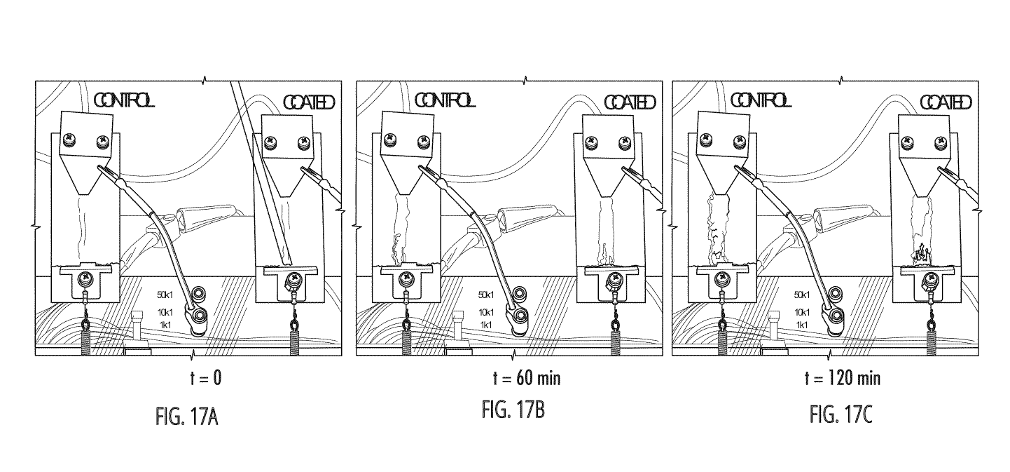

Flat samples, with and without a nanocomposite coating, were subjected to a tracking test by applying a 1 kV potential across the sample while simultaneously flowing a standard contaminant solution across its surface. The samples were photographed periodically throughout the test and a typical result is shown in FIG. 17. Tracking severity was greatly reduced for the coated flats in each of 3 repeated tests, as evidenced by a limited tracking path length.

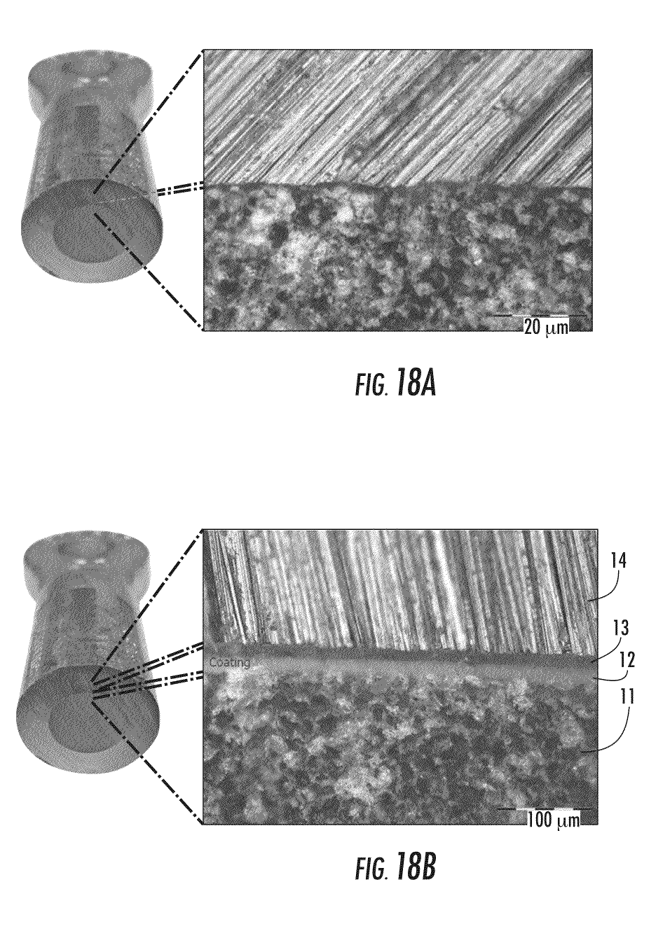

Dip-coated rods, 14 inches in length, were sent to the manufacturer to be fitted with standard crimped steel end fittings. The crimped rods were then cross sectioned and examined for signs of coating damage as a result of the crimping process. After cross sectioning, the samples were mounted and polished to reveal microstructural detail at the interface. FIG. 18 compares the cross sectional micrographs of control (uncoated) and coated rods. The micrographs clearly show the presence of an intact coating after crimp attachment of the end fitting, thus demonstrating the capability of the nanocomposite coating to endure the compressive stresses associated with the crimping process.

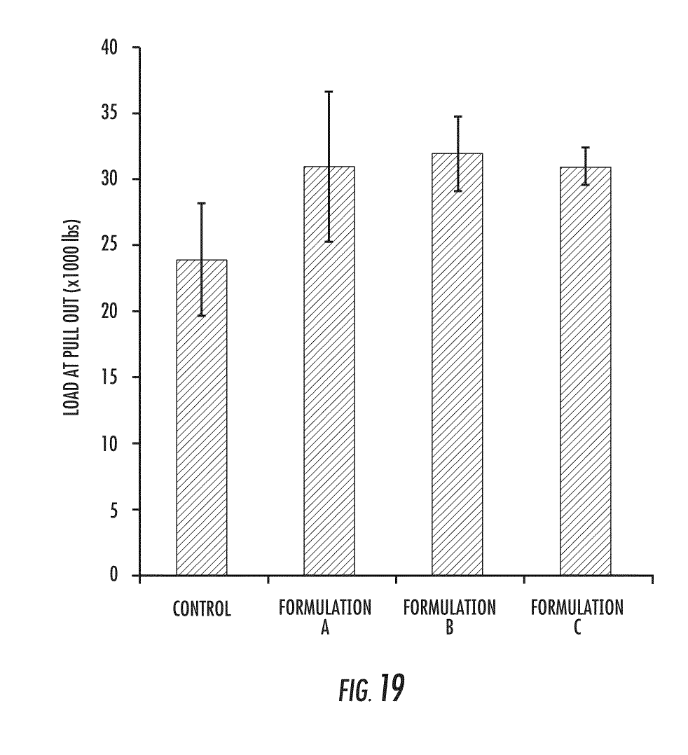

The manufacturer-crimped rods were then submitted for a standard pull test. In this test, the rod is placed under tension and the load is gradually increased until failure results. Both fracture and slippage of the rod from the end fitting are considered failure points. The data is graphed in FIG. 19. The presence of the coating consistently results in higher average pull strength.

The foregoing has described a composite component having a two layer protective coating. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A composite component adapted for use in the power transmission industry, comprising:
(a) a fiberglass inner core;
(b) a pliable first coating layer applied to the fiberglass core; and
(c) a hard second coating layer applied to the first coating layer.

2. The composite component according to claim 1, wherein the first coating layer is ultraviolet (UV) resistant to block ultraviolet light from penetrating into and degrading the fiberglass core.

3. The composite component according to claim 1, wherein the second coating layer provides mechanical resistance to scratching, abrasion, and impact to prevent the fiberglass core from being exposed to the environment.

4. The composite component according to claim 1, wherein the second coating layer is dense and provides a moisture barrier to the fiberglass core, thereby preventing stress corrosion cracking.

5. The composite component according to claim 1, wherein the first coating layer protects the second coating layer from cracking when fittings are crimped onto the composite component.

6. The composite component according to claim 5, wherein the first coating layer increases mechanical swage strength between the composite component and fittings due to the first coating layer being pliable and molding itself around the fiberglass core.

7. The composite component according to claim 1, wherein the first coating layer is formed of an epoxy matrix enriched with inorganic ultraviolet absorbers, wherein the inorganic ultraviolet absorbers protect the epoxy matrix from weathering by blocking light below 360 nanometers in wavelength.

8. The composite component according to claim 1, wherein the first coating layer is formed of a sol-gel coating solution enriched with ultraviolet absorbers, wherein the ultraviolet absorbers protect the fiberglass core from weathering by blocking light below 360 nanometers in wavelength.

9. The composite component according to claim 1, wherein the second coating layer is formed of a sol-gel coating solution.

10. The composite component according to claim 1, wherein the first and second coating layers are applied by a dip coating process.

11. The composite component according to claim 10, wherein thermal curing is used to cure each of the first and second coating layers.

12. A composite component adapted for use in the power transmission industry, comprising:
(a) a fiberglass inner core;
(b) a pliable first coating layer applied to the fiberglass core, wherein the first coating layer is enriched with ultraviolet absorbers to block ultraviolet light from penetrating into and degrading the fiberglass core; and
(c) a hard second coating layer applied to the first coating layer, wherein the second coating layer provides mechanical resistance to scratching, abrasion, and impact to prevent the fiberglass core from being exposed to the environment.

13. The composite component according to claim 12, wherein the second coating layer is dense and provides a moisture barrier to the fiberglass core, thereby preventing stress corrosion cracking.

14. The composite component according to claim 12, wherein the first coating layer molds itself around the fiberglass core to protect the second coating layer from cracking when fittings are crimped onto the composite component and to increase mechanical swage strength between the composite component and fittings crimped thereon.

15. The composite component according to claim 12, wherein the first and second coating layers are applied by a dip coating process.

16. The composite component according to claim 15, wherein thermal curing is used to cure each of the first and second coating layers.
